(19) United States
(12) Patent Application Publication
(10) Pub. No.: US 2013/0328404 A1
(43) Pub. Date: Dec. 12, 2013

(54) VOLTAGE CONVERSION APPARATUS, POWER GENERATION SYSTEM, AND VOLTAGE CONVERSION METHOD

(71) Applicant: Panasonic Corporation, Osaka (JP)

(72) Inventors: Shigekiyo NOSAKA, Fukuoka (JP); Hisao KOGA, Fukuoka (JP)

(21) Appl. No.: 13/913,197

(22) Filed: Jun. 7, 2013

(30) Foreign Application Priority Data
Jun. 11, 2012 (JP) 2012-131619

(51) Int. Cl. H02J 1/00

(52) U.S. Cl. CPC H02J 1/00
USPC 307/78; 323/205; 361/679.01

(57) ABSTRACT

A voltage conversion apparatus converts a voltage of an electricity generator. The voltage conversion apparatus includes a maximum power tracking portion that is adapted to output a voltage which is output by the electricity generator to an external device at a predetermined ratio such that an operation point of the electricity generator tracks an optimal operation point at which power of the electricity generator reaches a maximum level, and a voltage output portion that is adapted to output a voltage which is output by the electricity generator to the external device when the maximum power tracking portion is not being operated normally.

### BACKGROUND

1. Technical Field

The present invention relates to a maximum power point tracker used for electricity generation such as sunlight electricity generation, and particularly to a voltage conversion apparatus, a power generation system, and a voltage conversion method capable of suppressing a reduction in electricity generation efficiency.

2. Background Art

In recent years, sunlight electricity generation using sunlight energy which is eco-friendly and clean energy has attracted attention. An output of the sunlight electricity generation fluctuates depending on various conditions such as the seasons, time zones, and weather conditions and thus repeatedly rises and falls at all times. The maximum power point tracker (MPPT) is known which maximizes the output by controlling a voltage and a current at an appropriate balance.

In a centralized management method in which a plurality of sunlight panels are controlled by a single MPPT, there are cases where, if currents of some sunlight panels are reduced, operation points of the other sunlight panels are aligned with operation points of the some sunlight panels, and thus optimization of the overall outputs is difficult.

On the other hand, in a distribution method in which an MPPT is distributedly installed in each sunlight panel, since the sunlight panels can be optimized individually, even in a case where currents of some sunlight panels are reduced, the overall optimization can be realized (for example, refer to JP-A-2011-107904).

### SUMMARY

However, in a case of the MPPT of this distribution method, typically, when a DC/DC converter constituting the inside thereof fails, an internal circuit is disconnected, and thus the MPPT is bypassed. For example, in a case where a failure occurs in an MPPT connected to one sunlight panel among ten sunlight panels, the sunlight panel is bypassed, the entire system is constituted by nine sunlight panels, and thus an output voltage becomes reduced.

In a case where the MPPT fails but an electricity generation operation of the sunlight panels is normal, there is a disadvantage in that outputs of the sunlight panels which are normally operated are wasted.

One non-limited object of the present invention is to provide a voltage conversion apparatus, a power generation system, and a voltage conversion method capable of suppressing a reduction in electricity generation efficiency by preventing circumstances in which power of normally operated electricity generator cannot be supplied to an external device even if an MPPT fails.

A voltage conversion apparatus, a power generation system, and a voltage conversion method for converting a voltage of an electricity generator according to an aspect of the present invention, includes a maximum power tracking portion that outputs a voltage which is output by the electricity generator to an external device at a predetermined ratio such that an operation point of the electricity generator tracks an optimal operation point at which power of the electricity generator reaches a maximum level, and a voltage output portion that outputs a voltage which is output by the electricity generator to the external device when the maximum power tracking portion is not being operated normally.

In the voltage conversion apparatus, the power generation system, and the voltage conversion method, since power of the electricity generator can be output to an external device by the voltage output portion when the maximum power tracking portion is not being operated normally, it is possible to prevent circumstances in which the power cannot be supplied to the external device although the electricity generator is normally operated, and thus reduction in electricity generation efficiency can be suppressed.

### BRIEF DESCRIPTION OF THE DRAWINGS

FIG. 1 is a diagram illustrating an overall sunlight electricity generation system according to embodiments of the present invention.

FIG. 2 is a block diagram of the sunlight electricity generation system.

FIG. 3 is a block diagram of an MPPT device according to Embodiment 1.

FIG. 4 is a block diagram of an MPPT device according to Embodiment 2.

FIG. 5 is a circuit diagram of an MPPT device according to Embodiment 3.

FIGS. 6A and 6B are diagrams illustrating an operation example of a sunlight electricity generation system according to Embodiment 3.

FIG. 7 is a flowchart according to Embodiment 3.

FIG. 8 is a diagram illustrating a V-I characteristic according to Embodiment 3.

FIGS. 9A and 9B are diagrams illustrating a comparative example which is compared with the embodiment shown in FIGS. 6A and 6B.

FIGS. 10A and 10B are diagrams illustrating a comparative example which is compared with the embodiment shown in FIGS. 6A and 6B.

FIGS. 11A and 11B are diagrams illustrating a comparative example which is compared with the embodiment shown in FIGS. 6A and 6B.

FIG. 12A is a block diagram of an MPPT device according to Embodiment 4.

FIG. 12B is a perspective view of the MPPT device according to Embodiment 4.

FIG. 13A is a block diagram of a monitoring device according to Embodiment 5.

FIG. 13B is a perspective view of the monitoring device according to Embodiment 5.

FIG. 14 is a block diagram of a connection device according to Embodiment 6.

FIG. 15 is a diagram illustrating a sunlight panel according to Embodiment 7.

FIG. 16 is a diagram illustrating a junction box according to Embodiment 7.

FIG. 17 is a block diagram of a connection device.

### DETAILED DESCRIPTION

A first aspect of the present invention provides a voltage conversion apparatus for converting a voltage of an electricity generator, including: a maximum power tracking portion that is adapted to output a voltage which is output by the electricity generator to an external device at a predetermined ratio such that an operation point of the electricity generator tracks an optimal operation point at which power of the electricity generator reaches a maximum level; and a voltage output portion that is adapted to output a voltage which is output by the electricity generator to the external device when the maximum power tracking portion is not being operated normally.

According to the first aspect of the present invention, since power of the electricity generator can be output to an external device by the voltage output portion when the maximum power tracking portion is not being operated normally, it is possible to prevent circumstances in which the power cannot be supplied to the external device although the electricity generator is normally operated, and thus reduction in electricity generation efficiency can be suppressed.

A second aspect of the present invention provides the voltage conversion apparatus according to the first aspect, further including: a first housing that accommodates the voltage output portion; and a second housing that accommodates the maximum power tracking portion, wherein the first housing and the second housing are separable from each other.

According to the second aspect of the present invention, since the second housing accommodating the maximum power tracking portion is separable from the first housing when the maximum power tracking portion is not being operated normally, a worker can repair or exchange the maximum power tracking portion side without stopping the supply of power from the electricity generator. In addition, since the worker is not required to have contact with the voltage output portion side which outputs power, it is possible to increase work safety.

A third aspect of the present invention provides the voltage conversion apparatus according to the second aspect, wherein input and output terminals of the voltage output portion are provided on outside of the first housing, input and output terminals of the maximum power tracking portion are provided on outside of the second housing to be connected to the input and output terminals of the voltage output portion, and the input and output terminals of the voltage output portion and the input and output terminals of the maximum power tracking portion are disposed so as not to be exposed to outside of the voltage conversion apparatus when the first housing is connected to the second housing.

According to the third aspect of the present invention, since the input and output terminals of the voltage output portion and the input and output terminals of the maximum power tracking portion are not exposed to outside of the voltage conversion apparatus, it is possible to reduce a probability that a worker may come into contact with the input and output terminals and to thereby further increase work safety.

A fourth aspect of the present invention provides the voltage conversion apparatus according to any one of the first to third aspects, wherein the electricity generator generates power by using a photovoltaic.

According to the fourth aspect of the present invention, since the second housing accommodating the maximum power tracking portion is separable from the first housing when the maximum power tracking portion is not being operated normally, a worker can repair or exchange the maximum power tracking portion side without stopping the supply of power using a photovoltaic.

A fifth aspect of the present invention provides a power generation system including: a plurality of electricity generators; and the voltage conversion apparatus according to any one of the first to fourth aspects, connected to each of the plurality of electricity generators, wherein the plurality of electricity generators are connected in series to each other via the voltage conversion apparatuses.

According to the fifth aspect of the present invention, since the supply of power from the electricity generator is not stopped even if the maximum power tracking portion of any one of the voltage conversion apparatuses fails, it is possible to suppress a reduction in electricity generation efficiency of the entire system.

A sixth aspect of the present invention provides a voltage conversion method for converting a voltage of an electricity generator, including: outputting a voltage which is output by the electricity generator to an external device at a predetermined ratio such that an operation point of the electricity generator tracks an optimal operation point at which power of the electricity generator reaches a maximum level; and outputting a voltage which is output by the electricity generator to the external device when a normal operation fails in outputting the voltage at the predetermined ratio.

According to the sixth aspect of the present invention, since power of the electricity generator can be output to an external device by the voltage output step when the maximum power tracker is not being operated normally, it is possible to prevent circumstances in which the power cannot be supplied to the external device although the electricity generator is normally operated, and thus a reduction in electricity generation efficiency can be suppressed.

A seventh aspect of the present invention provides a connection device for outputting power from a sunlight panel, including: a first housing; and a second housing, wherein the first housing includes: an input side terminal that is connected to the sunlight panel; an output side terminal that can output the power to outside of the first housing; a first connection terminal that is connected to the input side terminal; and a second connection terminal that is connected to the output side terminal, the second housing includes: a third connection terminal; and a fourth connection terminal that is connected to the third connection terminal, and the first connection terminal is connected to the third connection terminal, and the second connection terminal is connected to the fourth connection terminal.

An eighth aspect of the present invention provides a connection device including: a housing; an input side terminal that is connected to a sunlight panel; an output side terminal that can output power of the sunlight panel to outside of the housing; a first connection terminal that is connected to the input side terminal; a second connection terminal that is connected to the output side terminal; and a connection control portion that is adapted to control an electrical connection state between the first connection terminal and the second connection terminal.

### Embodiment 1

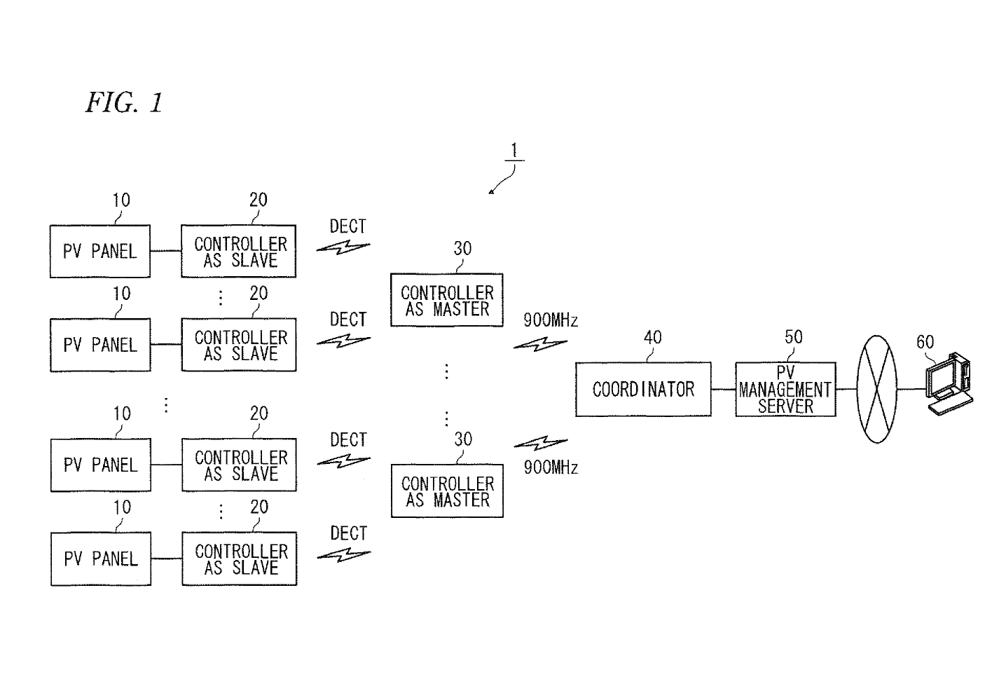

FIG. 1 is a diagram illustrating an overall sunlight electricity generation system according to embodiments of the present invention. A sunlight electricity generation system 1 is an example of the power generation system, and includes a plurality of sunlight panels (photovoltaic (PV) panels) 10. Each of the sunlight panels 10 is connected to a controller 20. The controller 20 has a function of the maximum power point tracker (MPPT), described later. A plurality of controllers 20 function as slaves and are managed by a controller 30 which functions as a master. Communication using Digital Enhanced Cordless Telecommunications (DECT; registered trademark) is performed between the controllers 20 and 30. In the following description, the controller 20 is referred to as an “MPPT device 20”. The MPPT device 20 is an example of the voltage conversion apparatus.

A coordinator 40 collectively manages a plurality of controllers 30 by using, for example, wireless communication of 900 MHz band. A PV management server 50 monitors data indicating an electricity generation state collected from each controller 30 by the coordinator 40. A user can view the monitored data as an image by using a PC 60 via a network such as the Internet.

In addition, the above-described communication method is not limited thereto, and various communication methods may be employed. For example, ZigBee (registered trademark) or 3G may be used. Further, a communication method is not limited to the wireless communication, and wired communication such as power line communication may be used. Furthermore, a sunlight panel is not limited to electricity generation using sunlight as long as it has a photovoltaic, and may use other light sources.

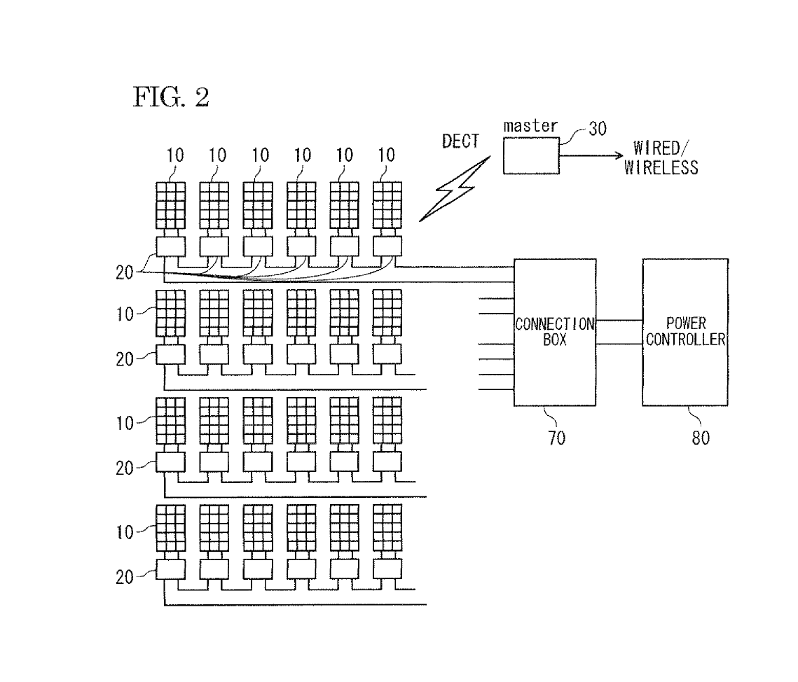

FIG. 2 is a block diagram of the sunlight electricity generation system. Six sunlight panels 10 on the uppermost part in FIG. 2 are connected in series to a connection box 70 via each MPPT device 20. The series-connected sunlight panels 10 (six panels in FIG. 2) forms a string as a single unit. In FIG. 2, four strings are formed, and line paths of the respective strings are collected (or lines are connected) at the connection box 70. The collected line paths are connected to a power controller 80. The MPPT function may also be mounted in the power controller 80. Alternatively, only the MPPT device 20 may have the MPPT function. In addition, the number of sunlight panels 10 forming a string is not particularly limited to six, and may be appropriately varied.

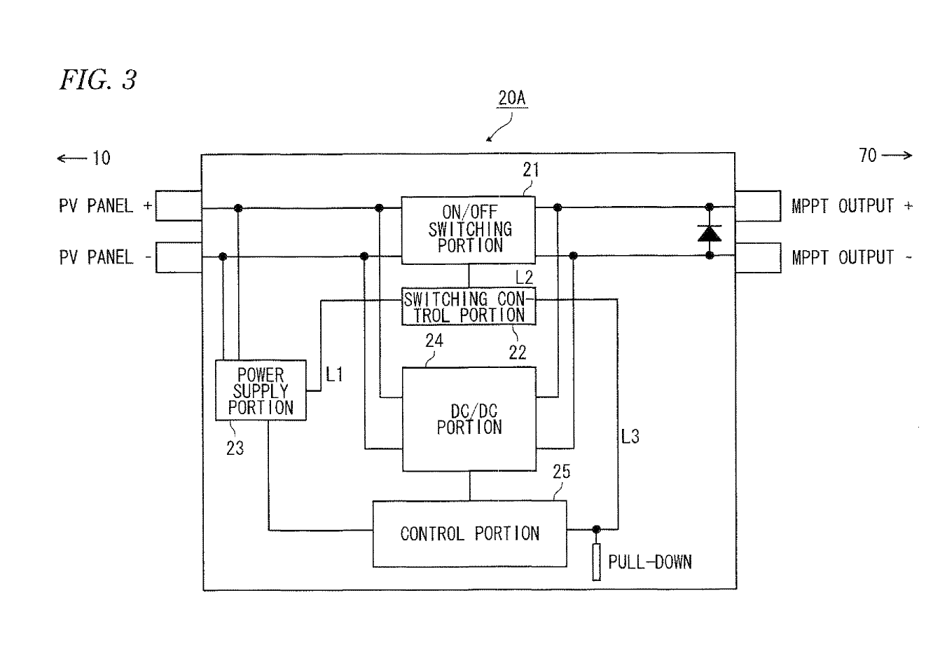

FIG. 3 is a block diagram of an MPPT device according to Embodiment 1. An MPPT device 20A includes a pair of input connectors connected to the sunlight panels 10 on the left side of FIG. 3. In addition, on the right side of FIG. 3, the MPPT device 20A includes a pair of output connectors connected to another MPPT (not shown) adjacent thereto or the connection box 70. A diode is connected to both ends of a pair of output connectors. The MPPT device 20A includes an ON/OFF switching portion (switch) 21, a switching control portion 22, a power supply portion 23, a DC/DC portion (DC-DC converter) 24, and a control portion 25. The ON/OFF switching portion 21 is formed by, for example, a MOSFET. The control portion 25 is typically formed by a microcomputer.

A pair of input connectors is connected to a pair of output connectors via the ON/OFF switching portion 21. The pair of input connectors is also connected to the power supply portion 23. The power supply portion 23 is connected to the switching control portion 22 and the control portion 25 so as to supply predetermined power thereto. The control portion 25 is connected to and controls the DC/DC portion 24. Further, the control portion 25 is connected to the switching control portion 22. The switching control portion 22 is connected to the ON/OFF switching portion 21, and the control portion 25 controls the ON/OFF switching portion 21 via the switching control portion 22. The DC/DC portion 24 is connected to both ends of the ON/OFF switching portion 21. In other words, the DC/DC portion 24 is connected in parallel to the ON/OFF switching portion 21.

Here, a potential of the line path which connects the power supply portion 23 to the switching control portion 22 is set to a potential L1. A potential of the line path which connects the switching control portion 22 to the ON/OFF switching portion 21 is set to a potential L2. A potential of the line path which connects the control portion 25 to the ON/OFF switching portion 21 is set to a potential L3.

The ON/OFF switching portion 21 is turned on when the potential L2 is high. That is, a closed circuit is formed, and thereby the path between the pair of output connectors and the pair of input connectors is connected. On the other hand, the ON/OFF switching portion 21 is turned off when the potential L2 is low. That is, an open circuit is formed, and thereby the path between the pair of output connectors and the pair of input connectors is disconnected.

The switching control portion 22 forms an XOR (exclusive logical addition) circuit which has the potentials L1 and L3 as inputs and has the potential L2 as an output. That is, if the potentials L1 and L3 are different from each other (either one is high or low), the switching control portion 22 outputs the potential L2 which is high. On the other hand, if the potentials L1 and L3 are the same as each other (both of the two are high or low), the switching control portion 22 outputs the potential L2 which is low.

In typical usage, both the potentials L1 and L3 are high, and thus the switching control portion 22 outputs the potential L2 which is low. Since the potential L2 is low, the ON/OFF switching portion 21 is turned off. When power generated by the sunlight panels 10 is input from the pair of input connectors, the power is output from the pair of output connectors via the DC/DC portion 24 without passing through the ON/OFF switching portion 21.

The DC/DC portion 24 outputs voltages which are output by the sunlight panels 10 to an external device at a predetermined ratio such that operation points of the sunlight panels 10 are controlled to track the optimal operation point at which power of the sunlight panels 10 reaches a maximum level. That is, voltages input from the pair of input connectors are increased or decreased and are output to an external device from the pair of output connectors.

Here, in a case where the DC/DC portion 24 is not being operated normally, for example, the DC/DC portion 24 fails, the control portion 25 sets the potential L3 to be low. Since the power supply portion 23 is normally operated, the potential L1 is also high, and thus the switching control portion 22 outputs the potential L2 which is high. The potential L2 is high, and thus the ON/OFF switching portion 21 is turned on. When power generated by the sunlight panels 10 is input from the pair of input connectors, since an input impedance of the DC/DC portion 24 is higher than that of the ON/OFF switching portion 21, the power is output from the pair of output connectors via the ON/OFF switching portion 21 without passing through the DC/DC portion 24. In this case, since tracking of operation points is not performed by the DC/DC portion 24, voltages of the sunlight panels 10 are output from the pair of output connectors as they are.

The DC/DC portion 24 is of a full-bridge type using a MOSFET. If power generated by the sunlight panels 10 is relatively large, the DC/DC portion 24 generates heat due to high-speed switching of the MOSFET, and thus there is a higher probability that the DC/DC portion 24 may fail than other constituent elements. When the DC/DC portion 24 fails, the MPPT device 20A is bypassed by the diode which is disposed between both ends of the pair of output connectors. As a result, the string including the six sunlight panels 10 shown in FIG. 2 is formed by five sunlight panels 10, and thus output voltages of the string becomes 5/6.

In the MPPT according to the present embodiment, even in a case where the DC/DC portion 24 fails and thus power cannot be transmitted with the path of the DC/DC portion 24, another path different from the path of the DC/DC portion 24 is formed by the ON/OFF switching portion 21 so as to isolate the DC/DC portion 24 in terms of a circuit, and thus power which is output by the sunlight panels 10 can be continuously output. Particularly, in a case where the sunlight panels are normally operated, the path is not disconnected by the DC/DC portion 24, and thereby it is possible to prevent power output by the sunlight panels 10 from being wasted.

In addition, since the potential L3 is set to be low in a case where the control portion 25 fails as well, the switching control portion 22 outputs the potential L2 which is high so as to turn on the ON/OFF switching portion 21 when the control portion 25 fails in the same manner as the case where the DC/DC portion 24 fails. Therefore, even in a case where the control portion 25 fails, the DC/DC portion is isolated in terms of a circuit, and thus power which is output by the sunlight panels 10 can be continuously output.

As described above, in Embodiment 1, when the DC/DC portion 24 or the control portion 25 of the MPPT device fails, a bypass path from the ON/OFF switching portion 21 is formed, and thus power generated by the sunlight panels 10 can be output to an external device via the MPPT without waste.

In a case where the power supply portion 23 fails and the potential L1 is low, since power cannot be supplied to the control portion 25 or the switching control portion 22, the potential L2 of the switching control portion 22 automatically becomes low so as to turn off the ON/OFF switching portion 21 regardless of whether or not the DC/DC portion 24 and the control portion 25 are normally operated.

### Embodiment 2

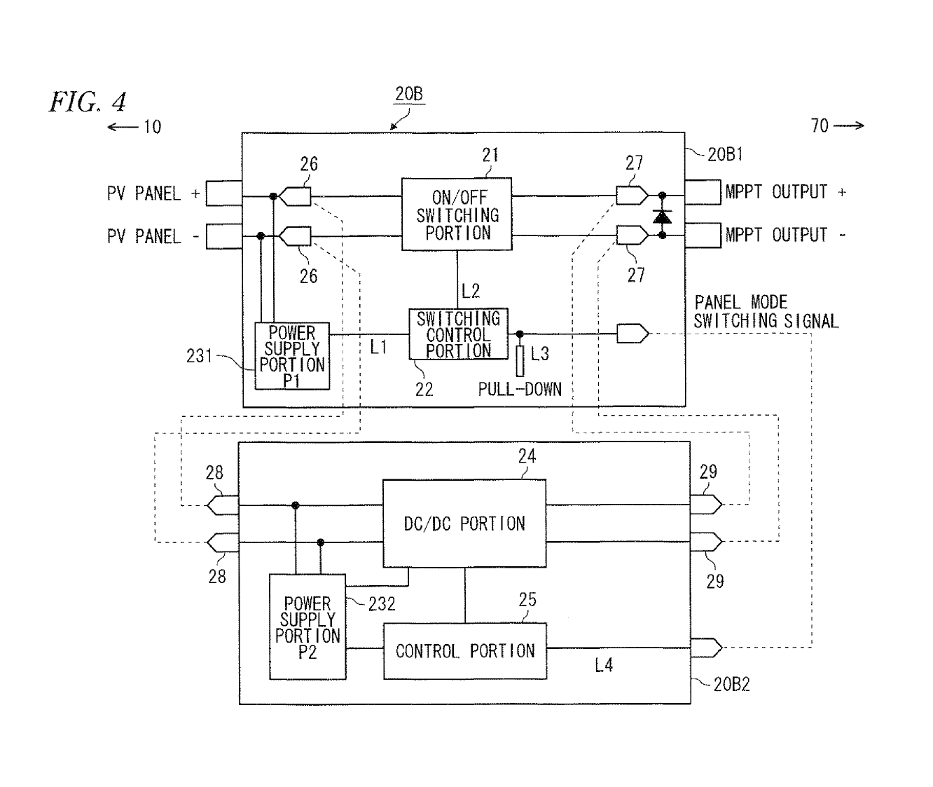

FIG. 4 is a block diagram of an MPPT device according to Embodiment 2. Embodiment 2 is different from Embodiment 1 in that the MPPT device 20B is separable into two units including a bypass unit 20B1 and a conversion unit 20B2 as shown in FIG. 4. The same constituent element is given the same reference numeral as in FIG. 3, and description thereof will be omitted.

The bypass unit 20B1 includes an ON/OFF switching portion 21, a switching control portion 22, and a power supply portion 231. A pair of connection terminals 26, 26 are respectively provided in paths between a pair of input connectors and the ON/OFF switching portion 21. In addition, a pair of connection terminals 27, 27 are respectively provided in paths between a pair of output connectors and the ON/OFF switching portion 21. The switching control portion 22 is provided with a switching signal terminal to which a panel mode switching signal can be input. The respective constituent elements (the ON/OFF switching portion 21, the switching control portion 22, and the power supply portion 231) of the bypass unit 20B1 are accommodated in a housing (not shown). The housing is made of, for example, plastic and is formed in a box shape, and the connection terminals 26, 26, 27, 27 and the switching signal terminal are disposed on one surface (for example, an upper surface or a side surface) of the box.

The conversion unit 20B2 includes a DC/DC portion 24, a control portion 25, and a power supply portion 232. The DC/DC portion 24 is provided with connection terminals 28, 28 which are respectively connected to a pair of input terminals (the left side in FIG. 4). The DC/DC portion 24 is provided with connection terminals 29, 29 which are respectively connected to a pair of output terminals (the right side in FIG. 4). The control portion 25 is provided with a switching signal terminal from which a panel mode switching signal can be output. The respective constituent elements (the DC/DC portion 24, the control portion 25, and the power supply portion 232) of the conversion unit 20B2 are accommodated in a housing (not shown). The housing is made of, for example, plastic and is formed in a box shape, and the connection terminals 28, 28, 29, 29 and the switching signal terminal are disposed on one surface (for example, a lower surface or a side surface) of the box.

Before being used, first, the conversion unit 20B2 is attached to the bypass unit 20B1 such that the lower surface of the conversion unit 20B2 faces the upper surface of the bypass unit 20B1. When the upper surface of the bypass unit 20B1 faces the lower surface of the conversion unit 20B2, the connection terminals 26, 26 are electrically connected to the connection terminals 28, 28, the connection terminals 27, 27 are electrically connected to the connection terminals 29, 29, and the switching signal terminals are electrically connected to each other. In this way, the same circuit configuration as the MPPT device 20A of FIG. 3 is built in terms of an equivalent circuit.

Here, when the DC/DC portion 24 or the control portion 25 of the conversion unit 20B2 fails, in the same manner as Embodiment 1, a bypass path from the ON/OFF switching portion 21 is formed, and thus power generated by the sunlight panels 10 can be output to an external device via the MPPT without waste.

In a case where a worker repairs a failed MPPT in this state, the conversion unit 20B2 is detached from the units forming the MPPT device 20B. Handles (not shown) are provided on the surface (that is, the surface in which the connection terminals 26, 27, 28, 29 are not exposed) other than the lower surface in the housing of the conversion unit 20B2, and the worker holds the handles and detaches the conversion unit 20B2 from the bypass unit 20B1. The handles may have any shape or aspect as long as the worker can hold the conversion unit 20B2. As above, since the connection terminals are disposed apart from the place where the worker touches the MPPT, a possibility of an electric shock can be reduced, and thus safety can increase.

As described above, in Embodiment 2, since the MPPT is formed so as to divide the configuration including the DC/DC portion in which a probability of failure is relatively high as a separate body, in a case where the DC/DC portion or peripheral constituent elements thereof fail, the DC/DC portion or peripheral constituent elements thereof can be detached for repair or changing parts without shutting off a power output from the sunlight panels.

In addition, since the configuration including the DC/DC portion can be divided as a separate body, the inside of the MPPT is not required to be disassembled. Therefore, a probability of an electric shock can be reduced, and thus safety can increase.

Although, in the above-described Embodiments 1 and 2, a description has been made of a case where the DC/DC portion 24 and the control portion 25 fail as an example in which the MPPT function of the MPPT device is not being operated normally, Embodiments 1 and 2 are also applicable to a case where circuits, parts, and constituent elements other than the DC/DC portion 24 and the control portion 25 are not being operated normally among the constituent elements of the MPPT device. In addition, the “normal operation” indicates that the MPPT device is operated according to a specification thereof, and, specifically, an operation in which an operation point tracks the optimal operation point is performed as regulated in the specification. Therefore, the “abnormal operation” includes not only a simple failure state but also a case where an operation departing from the specification is performed or a case where a normal operation cannot be continuously performed (for example, a normal operation is intermittently performed).

### Embodiment 3

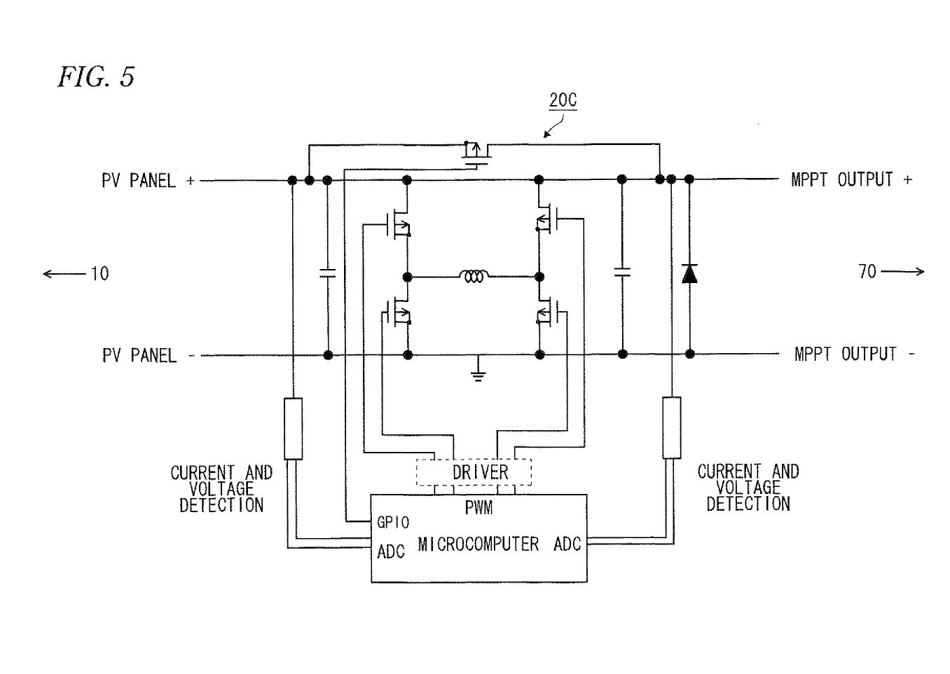

FIG. 5 is a circuit diagram of an MPPT device according to Embodiment 3. A microcomputer and a driver of an MPPT device 20C correspond to the control portion 25 of FIG. 3. Four MOSFETs connected to an inductor of the MPPT device 20C correspond to the DC/DC portion 24 of FIG. 3. A MOSFET (the upper part of FIG. 5) of the MPPT device 20C corresponds to the ON/OFF switching portion 21 of FIG. 3. In the MPPT device 20C according to this Embodiment 3, the MOSFET corresponding to the ON/OFF switching portion 21 is turned on in the same manner as in Embodiments 1 and 2 in a case where the MOSFETs forming the DC/DC portion or the microcomputer is not being operated normally. In addition, in Embodiment 3, control by the ON/OFF switching portion 21 is not necessarily required.

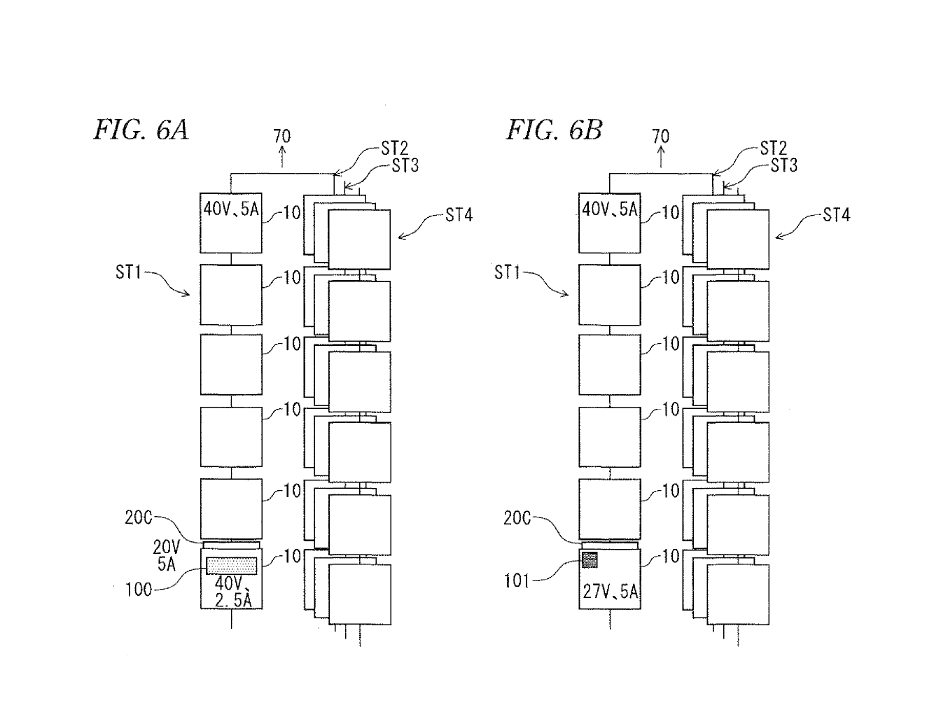

FIGS. 6A and 6B are diagrams illustrating an operation example of a sunlight electricity generation system according to Embodiment 3. The sunlight electricity generation system includes four strings ST1, ST2, ST3 and ST4. In each of the strings ST1, ST2, ST3 and ST4, six sunlight panels 10 are connected in series to each other. Each of the sunlight panels 10 is assumed to output power of the voltage of 40 V and the current of 5 A. The MPPT device 20C is connected to one sunlight panel 10 of the string ST1.

In FIG. 6A, in a case where a thin shadow 100 is cast on the sunlight panel 10 connected to the MPPT device 20C, some of clusters inside the sunlight panel 10 form a resistance component. As a result, electricity generation efficiency of the sunlight panel 10 is reduced, and output power of the sunlight panel 10 is reduced from the voltage of 40 V and the current of 5 A to, for example, the voltage of 40 V and the current of 2.5 A. Next, as shown in FIG. 6B, if a dark shadow 101 is cast on the sunlight panel 10, clusters forming a resistance component are bypassed by diodes disposed between the clusters. As a result, output power of the sunlight panel 10 varies from the voltage of 40 V and the current of 2.5 A to, for example, the voltage of 27 V and the current of 5 A, and thus the current returns to the original value.

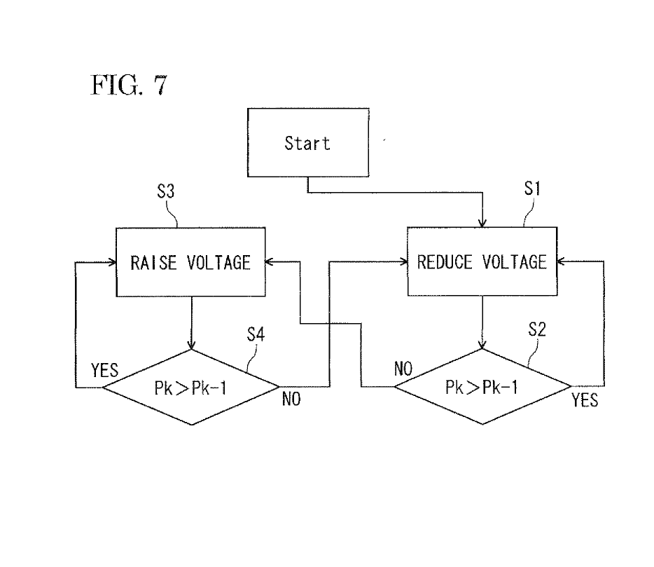

FIG. 7 is a flowchart according to Embodiment 3, and shows an operation of the MPPT. When a voltage of the sunlight panel 10 is reduced in step S1, power Pk of the sunlight panel 10 at the current point is compared with past power Pk-1 (a predetermined time ago) of the sunlight panel 10 in step S2. If Pk is greater than Pk-1 (Yes in S2), the voltage decreases by a predetermined value. After the voltage decreases, if Pk is smaller than Pk-1 (No in S2), the voltage is raised by a predetermined value in step S3. After the voltage increases, Pk is compared with Pk-1 in step S4, and if Pk is greater than Pk-1 (Yes in S4), the voltage increases by a predetermined value. After the voltage increases, if Pk is smaller than Pk-1 (No in S4), the flow returns to step S1 where the voltage decreases.

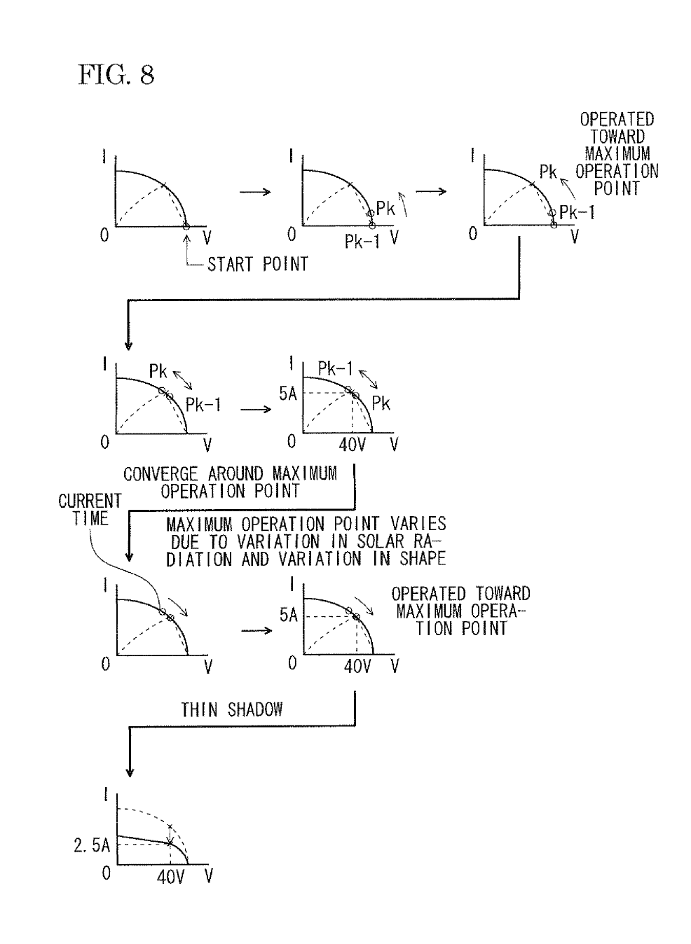

FIG. 8 is a diagram illustrating a V-I characteristic according to Embodiment 3. The V-I characteristic of the sunlight panel is shown, and the circle in FIG. 8 indicates an operation point. The operation point rises from a start point, and moves toward the maximum operation point. The operation point converges around the maximum operation point, but the maximum operation point is shifted due to a variation in solar radiation or a variation in shadow.

As described with reference to FIG. 6A, if a thin shadow is cast on the sunlight panel 10, the solar radiation decreases, and thus output power of the sunlight panel 10 is reduced from the voltage of 40 V and the current of 5 A to, for example, the voltage 40 V and the current of 2.5 A as shown on the lower left side of FIG. 8.

In the present embodiment, the microcomputer (refer to FIG. 5) of the MPPT device 20C detects a current and a voltage of the sunlight panel 10, and is set to control the MOSFETs forming the DC/DC portion via the driver such that the current is returned, in a case where the current output from the sunlight panel 10 becomes a predetermined value. Here, a threshold value is set to 2.5 A, but is not limited thereto, and a threshold value may be appropriately changed.

Therefore, the microcomputer of the MPPT device 20C detects that the current output from the sunlight panel 10 becomes 2.5 A, and controls the DC/DC portion so as to perform a conversion process on the voltage and the current. In this case, the voltage of 40 V and the current of 5 A are converted into, for example, the voltage of 20 V and the current of 5 A. In this way, it is possible to prevent currents of the overall strings from being reduced by the clusters of the sunlight panel 10 forming a resistance component due to a thin shadow.

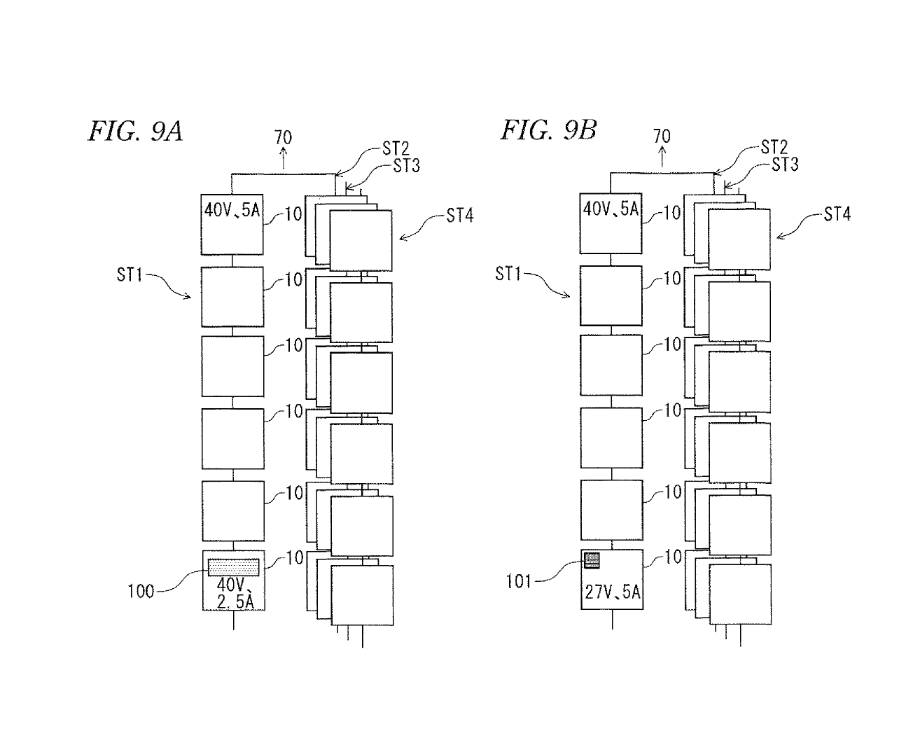

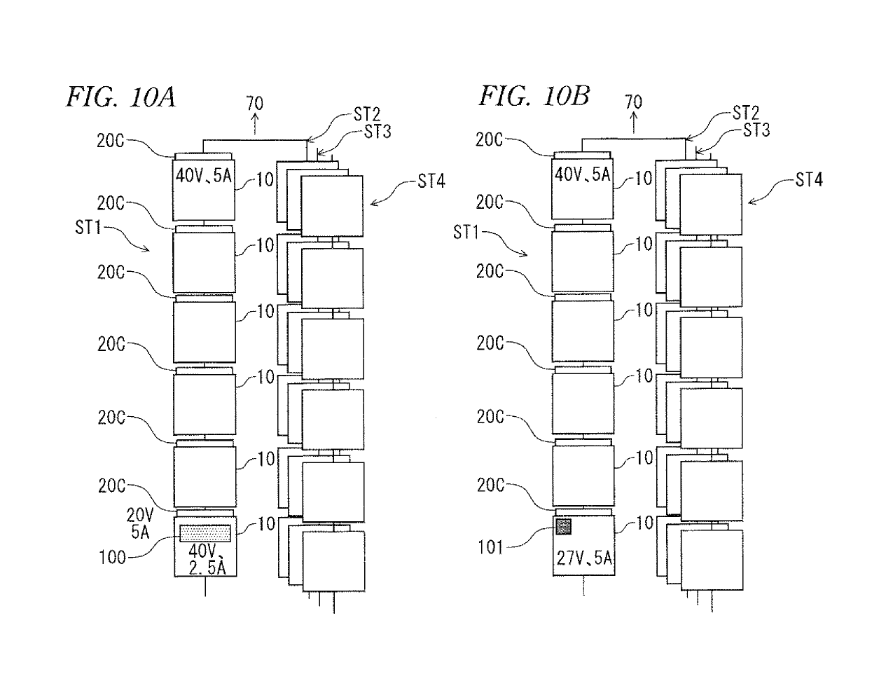

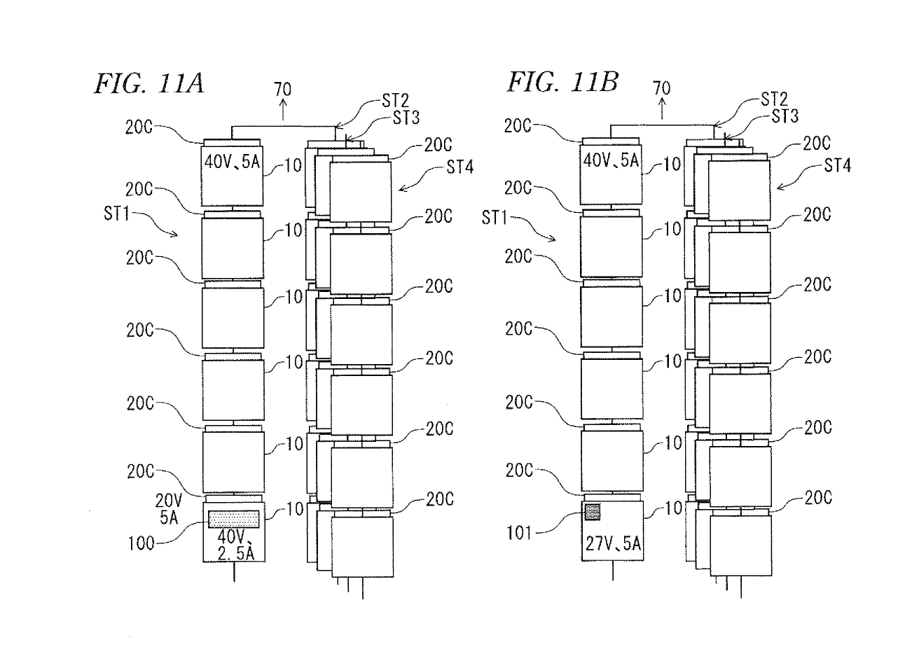

FIGS. 9A to 11B are diagrams illustrating comparative examples compared with the embodiment shown in FIGS. 6A and 6B. Specifically, FIGS. 9A and 9B show an example in which the MPPT device is not connected, FIGS. 10A and 10B show an example in which the MPPT devices are connected to only one string, and FIGS. 11A and 11B show an example in which the MPPT devices are connected to all the strings.

TABLE 1

| STATE OF | MPPT | MPPT | MPPT | MPPT |
|---|---|---|---|---|
| SHADOW | (ABSENT) | (SOME) | (STRING) | (ALL) |
| THIN | 4200 W | 4607 W (9.6% | 4667 W | 4649 W |
| SHADOW | (FIG. 9A) | UP) | (11.1% UP) | (10.6% UP) |
| | | (FIG. 6A) | (FIG. 10A) | (FIG. 11A) |
| DARK | 4675 W | 4671 W (0.1% | 4671 W | 4682 W |
| SHADOW | (FIG. 9B) | DOWN) | (0.5% UP) | (0.1% UP) |
| | | (FIG. 6B) | (FIG. 10B) | (FIG. 11B) |

Note that the rate of change as mentioned is a value with respect to MPPT (ABSENT)

Table 1 shows a comparison result of power of the present embodiment (MPPT (some)) and power of the comparative examples (MPPT (absent), MPPT (string), and MPPT (all)) shown in FIGS. 9A to 11B. This table shows that, in a dark shadow, there is little difference between them, but, in a thin shadow, the power of 4200 W is obtained at MPPT (absent), and the power 4600 W or more can be obtained when the MPPT is connected to some sunlight panels. That is, by connecting the MPPT device to only sunlight panels on which a thin shadow may be cast, it is possible to generate power equivalent thereto without connecting the MPPT devices to all sunlight panels or connecting the MPPT devices to all sunlight panels of a single string.

In the present embodiment as described above, the MPPT device is provided in some of the sunlight panels of the string. Thereby, even if a thin shadow is cast on the sunlight panel, it is possible to suppress reduction in current and to thereby suppress reduction in electricity generation efficiency of the entire system.

### Embodiment 4

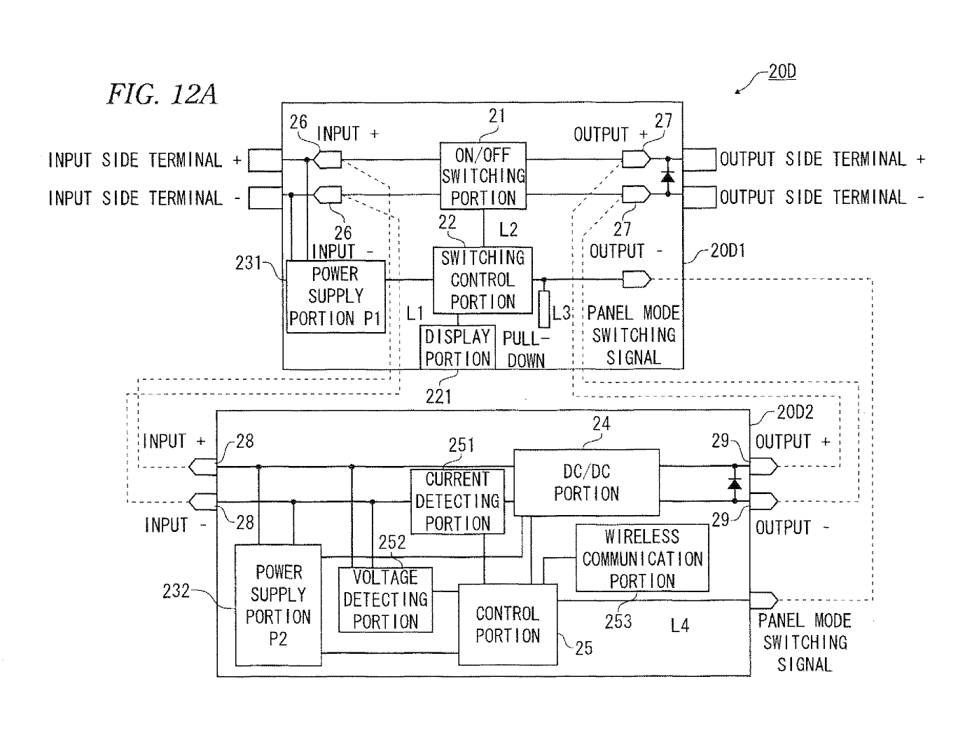

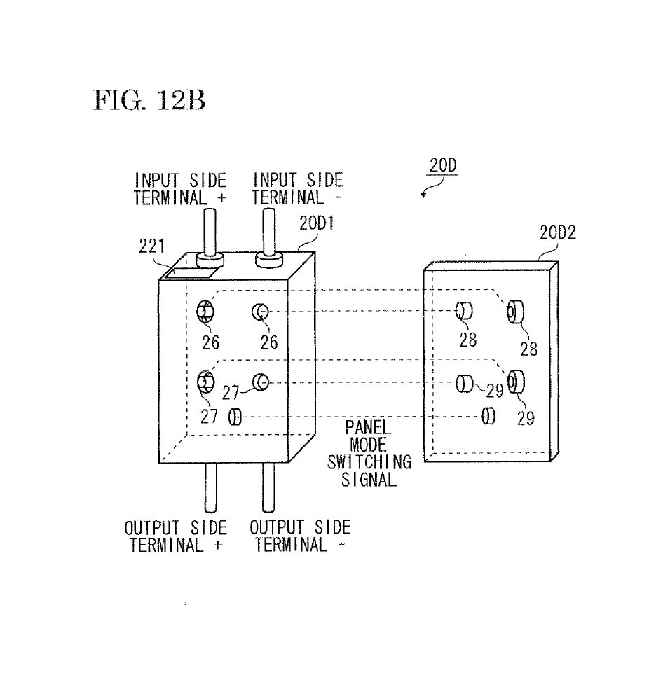

Next, Embodiment 4 will be described with reference to FIGS. 12A and 12B. FIG. 12A is a block diagram of an MPPT device according to Embodiment 4. FIG. 12B is a perspective view of the MPPT device according to Embodiment 4. The above-described functions and constituent elements are given the same reference numerals, and detailed description thereof will be omitted.

An MPPT device 20D includes a bypass unit 20D1 and a conversion unit 20D2. In the same manner as the above-described Embodiment 2, the bypass unit 20D1 and the conversion unit 20D2 are attachable and detachable.

The bypass unit 20D1 further includes a display portion 221 in the housing of the bypass unit 20B1 in addition to the configuration of the above-described bypass unit 20B1. The display portion 221 notifies a user of turned-on and turned-off states of the ON/OFF switching portion 21. A display state of the display portion 221 is controlled by the switching control portion 22. That is, the switching control portion 22 changes turned-on and turned-off states of the ON/OFF switching portion 21 and changes display of the display portion 221. As above, the display portion 221 can notify a worker who attaches or detaches the conversion unit 20D2 of turned-on and turned-off states of the ON/OFF switching portion 21. Therefore, since the worker can check whether or not an attachment or detachment work of the conversion unit 20D2 is completed without accident, it is possible to suppress inconvenience of the detachment or electrical inconvenience of the sunlight electricity generation system due to the detachment.

In addition, the switching control portion 22 may simultaneously perform a change between turned-on and turned-off states of the ON/OFF switching portion 21 and a change in display of the display portion 221, or may perform the two changes at different timings.

In addition, as a method of notifying of turned-on and turned-off states of the display portion 221 characters such as “ON” and “OFF”, or “panel (bypass) mode” and “MPPT mode” may be displayed. In addition, the panel (bypass) mode indicates a state in which the ON/OFF switching portion 21 is turned off, and the MPPT mode indicates a state in which the ON/OFF switching portion 21 is turned on. Alternatively, simply, a worker may be notified of the turned-on and turned-off states by using emission states of a light bulb such as an LED. The emission states here include, for example, emission colors, lighting, lighting-off, blinking, and the like.

The conversion unit 20D2 includes a current detecting portion 251, a voltage detecting portion 252, and a wireless communication portion 253 in addition to the configuration of the above-described conversion unit 20B2.

The current detecting portion 251 detects a current which is output by the sunlight panel 10 connected to the MPPT device 20D. That is, the current detecting portion 251 detects a current which is input to the MPPT device 201) (or the conversion unit 20D2). The current detecting portion 251 notifies the control portion 25 of the detected current. The control portion 25 performs MPPT control on the sunlight panel 10 by using the current input from the current detecting portion 251, and transmits the detected current to the controller 30 via the wireless communication portion 253.

The voltage detecting portion 252 detects a voltage (a potential difference between the input + and the input −) which is output by the sunlight panel 10 connected to the MPPT device 20D. That is, the voltage detecting portion 252 detects a voltage which is input to the MPPT device 20D (or the conversion unit 20D2). The voltage detecting portion 252 notifies the control portion 25 of the detected voltage. The control portion 25 performs MPPT control on the sunlight panel 10 by using the voltage input from the voltage detecting portion 252, and transmits the detected voltage to the controller 30 via the wireless communication portion 253.

In addition, although, in the present embodiment, the current detecting portion 251 and the voltage detecting portion 252 are provided only on the input side of the DC/DC portion 24, the current detecting portion 251 and the voltage detecting portion 252 may also be provided on the output side in the same manner as the MPPT device 20C shown in FIG. 5. In a case where the current detecting portion 251 and the voltage detecting portion 252 are also provided on the output side, the current detecting portion 251 and the voltage detecting portion 252 on the output side respectively detect an output current and an output voltage of the DC/DC portion 24 so as to notify the control portion 25. Thereby, the control portion 25 transmits voltages and currents on the input side and the output side of the DC/DC portion 24 to the controller 30 via the wireless communication portion 253. Therefore, the controller 30 or the coordinator 40 can more accurately determine whether or not the DC/DC portion 24 is normally operated.

### Embodiment 5

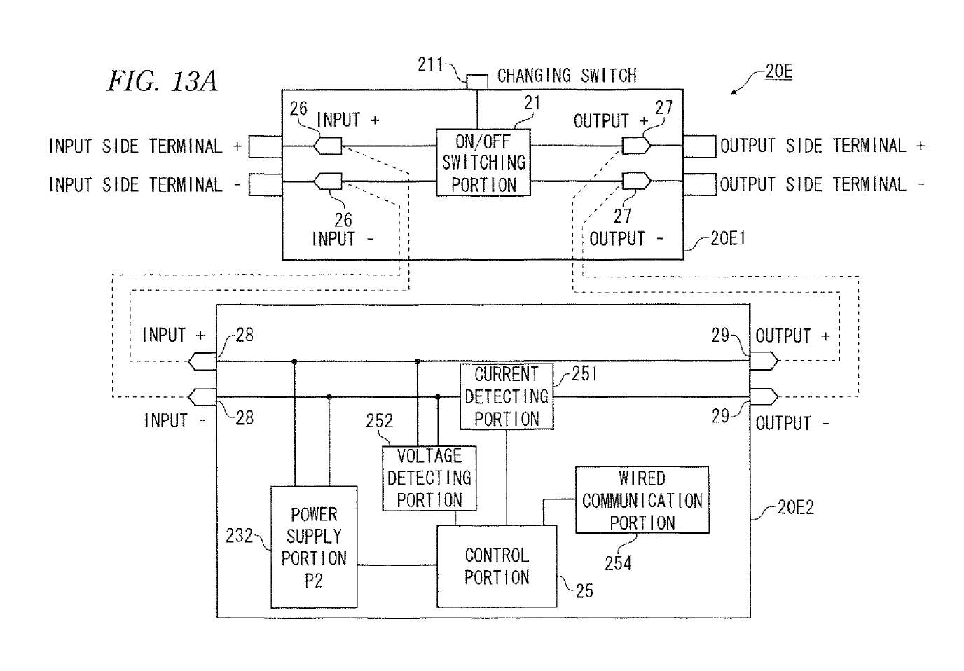

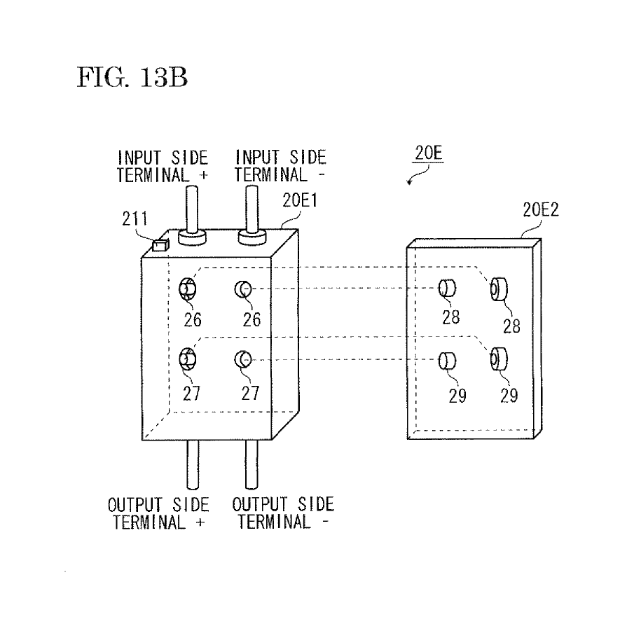

Next, Embodiment 5 will be described with reference to FIGS. 13A and 13B. FIG. 13A is a block diagram of a monitoring device according to Embodiment 5. FIG. 13B is a perspective view of the monitoring device according to Embodiment 5. The above-described functions and constituent elements are given the same reference numeral, and detailed description thereof will be omitted.

A monitoring device 20E includes a bypass unit 20E1 and a monitoring unit 20E2. The bypass unit 20E 1 and the monitoring unit 20E2 are attachable and detachable in the same manner as in the above-described Embodiments 2 and 4.

The bypass unit 20E 1 has a configuration in which a changing switch (switch) 211 is provided instead of the switching control portion 22. The changing switch 211 is connected to the ON/OFF switching portion 21, and has a function of changing turned-on and turned-off states of the ON/OFF switching portion 21. The changing switch 211 is provided on outside or a surface of a housing (not shown) of the bypass unit 20E1. In addition, the changing switch 211 may be a mechanical switch or an electrical switch. A power supply portion 232 may be provided inside the bypass unit 20E1 in order to supply power to the electrical switch of the bypass unit 20E1.

A worker changes turned-on and turned-off states of the ON/OFF switching portion 21 by using the changing switch 211. That is, the worker changes a state of the ON/OFF switching portion 21 from a turned-off state to a turned-on state by using the changing switch 211 when the monitoring unit 20E2 is detached from the bypass unit 20E1. In addition, output power of the sunlight panel 10 is output without passing through the monitoring unit 20E2. Thereby, the monitoring unit 20E2 is electrically disconnected from the sunlight electricity generation system 1, and thus the worker can safely detach the monitoring unit 20E2. On the other hand, when the monitoring unit 20E2 is attached to the bypass unit 20E1, the worker changes a state of the ON/OFF switching portion 21 from a turned-on state to a turned-off state by using the changing switch.

The monitoring unit 20E2 has a configuration in which the DC/DC portion 24 is omitted from the conversion unit 20D2. The monitoring unit 20E2 includes a current detecting portion 251 and a voltage detecting portion 252, and the current detecting portion 251 detects a current output by the sunlight panel 10, and the voltage detecting portion 252 detects a voltage output by the sunlight panel 10. The control portion 25 transmits the current and the voltage detected by the current detecting portion 251 and the voltage detecting portion 252 to the controller 30 via a wired communication portion 254.

Thereby, output information (currents, voltages, power, and the like) of the respective sunlight panels 10 can be collected at the controller 30. In addition, the collected output information of the respective sunlight panels 10 may be managed by the PV management server 50 and may also be displayed by the PC 60.

In addition, the PV management server 50 can recognize an output state of each sunlight panel 10 and thus can detect a failure of the sunlight panel 10. When a failure is detected, the PV management server 50 notifies a manager, an owner, or the like of the sunlight electricity generation system 1 of a warning. Therefore, since a failed sunlight panel 10 can be found early and can be repaired, it is possible to suppress electricity generation loss of the sunlight electricity generation system 1.

In addition, an apparatus which detects occurrence of a failure may not be the PV management server 50, and may be any one of the monitoring device 20E (the controller 20), the controller 30, the coordinator 40, and the PC 60. Alternatively, other apparatuses may detect a failure of the sunlight panel 10. In addition, means for notifying the manager, the owner, or the like of a warning after detecting a failure is not particularly limited, and the PC 60 may notify of a warning or other apparatuses may notify of a warning.

In addition, the wired communication portion 254 may perform communication with the controller 30 by using a dedicated communication line provided between the wired communication portion 254 and the controller 30. Alternatively, the wired communication portion 254 may perform communication with the controller 30 by using power line communication. That is, the controller 30 is connected to a power line (for example, a string) of the sunlight electricity generation system 1, and the wired communication portion 254 communicates with the controller 30 via the power line. In this case, the controller 30 also has the wired communication portion 254.

### Embodiment 6

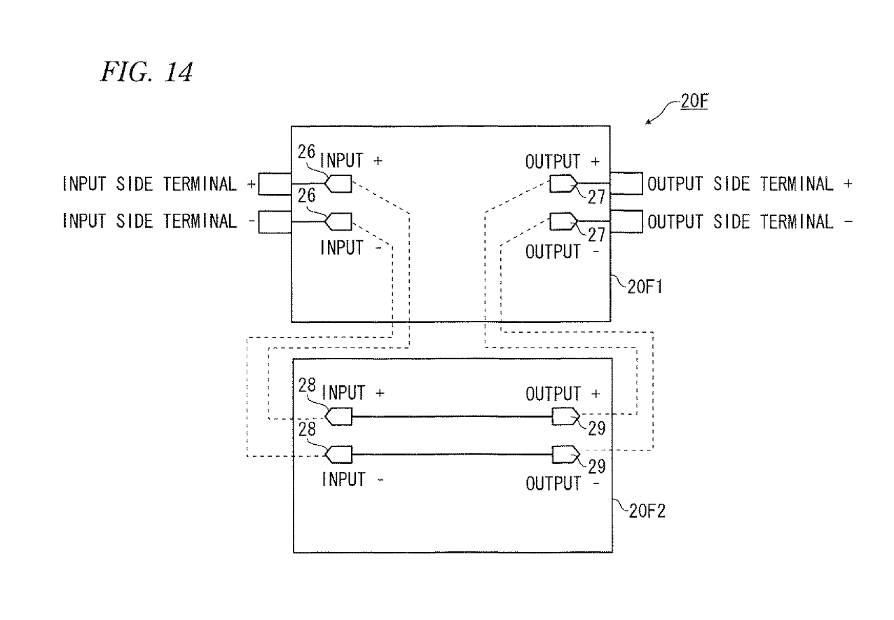

Next, Embodiment 6 will be described with reference to FIG. 14. FIG. 14 is a block diagram of a connection device according to Embodiment 6. The above-described functions and constituent elements are given the same reference numeral, and detailed description thereof will be omitted.

A connection device 20F includes a bypass unit 20F 1 and a connection unit 20F2. In the same manner as in the above-described Embodiments 2, 4 and 5, the bypass unit 20F 1 and the connection unit 20F2 are attachable and detachable. In addition, an exterior of the connection device 20F is the same as that of the monitoring device 20E shown in FIG. 13B.

The bypass unit 20F1 has a configuration in which various functions are omitted from the above-described conversion units 20B2, 20D2 or monitoring unit 20E2. The bypass unit 20F1 at least includes connection terminals 26 and 27, input side terminals, and output side terminals. Each of the connection terminals 26 and 27, the input side terminals, and the output side terminals is a pair of terminals, and a positive side and a negative side are present in a pair of terminals. In addition, the connection terminals 26 and the input side terminals are terminals on the input side. The connection terminals 26 are electrically connected to the sunlight panel 10, and the input side terminals are connected to the connection terminals 26 via power lines. The connection terminals 27 and the output side terminals are terminals on the output side. The connection terminals 27 are connected to the connection box 70 via power lines, and the output side terminals are connected to the connection terminals 27. In addition, the connection terminals 27 may be directly connected to the power controller 80 via power lines.

The connection unit 20F2 includes connection terminals 28 and 29. Each of the connection terminals 28 and 29 is a pair of terminals, and a positive side and a negative side are present in a pair of terminals. The connection terminals 28 are terminals on the input side, and the connection terminals 29 are terminals on the output side. The connection terminals 28 are connected to the connection terminals 26, and the connection terminals 29 are connected to the connection terminals 27. That is, power which is output by the sunlight panel 10 is transmitted in order of the input side terminals, the connection terminals 26, the connection terminals 28, the connection terminals 29, the connection terminals 27, and the output side terminals, and is output to outside of the connection device 20F.

In the connection device 20F, the bypass unit 20F1 and the connection unit 20F2 are provided as separate bodies as described above, and thus the connection unit 20F2 can be easily detached.

Hereinafter, a description will be made of effects when the connection device 20F is attached to the sunlight panel 10.

Generally, there is a sunlight electricity generation system in which the controller 20 such as the MPPT devices 20A to 201) or the monitoring device 20E described in the embodiments is not installed. In addition, the sunlight electricity generation system deteriorates, and thus electricity generation efficiency of the system may be reduced. Alternatively, the sunlight panel may fail due to usage for a long time. However, in a case where a new controller 20 is installed in the system of which wiring is completed, a worker is required to perform wiring of the sunlight electricity generation system again, and thus considerable labor is taken place. In addition, due to this labor, the cost is high which an owner of the sunlight electricity generation system pays for installation of the new controller 20. Therefore, it is difficult to install the controller 20 in the sunlight electricity generation system which has already been operated once.

From the above-described background, the connection device 20F which does not have the MPPT function and the monitoring function is installed in advance in each sunlight panel 10 of the sunlight electricity generation system 1 according to the present embodiment. Therefore, the conversion units 20B2 and 20D2 having the MPPT function or the monitoring unit 20E2 having the monitoring function can be easily installed in the sunlight electricity generation system 1 without performing new wiring. For example, even if a surrounding environment of the sunlight electricity generation system 1 varies and thereby a shadow enters some of the sunlight panels 10, the conversion units 20B2 and 20D2, and the like can be easily installed in the sunlight panels 10. For example, effects when the MPPT device is installed in some of the sunlight panels 10 are the same as described with reference to Table 1. Therefore, it is possible to easily suppress a reduction in electricity generation efficiency of the sunlight electricity generation system 1 due to the variation in a surrounding environment.

### Embodiment 7

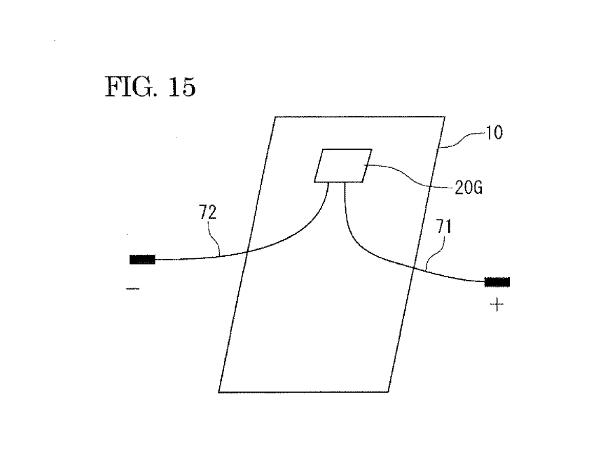

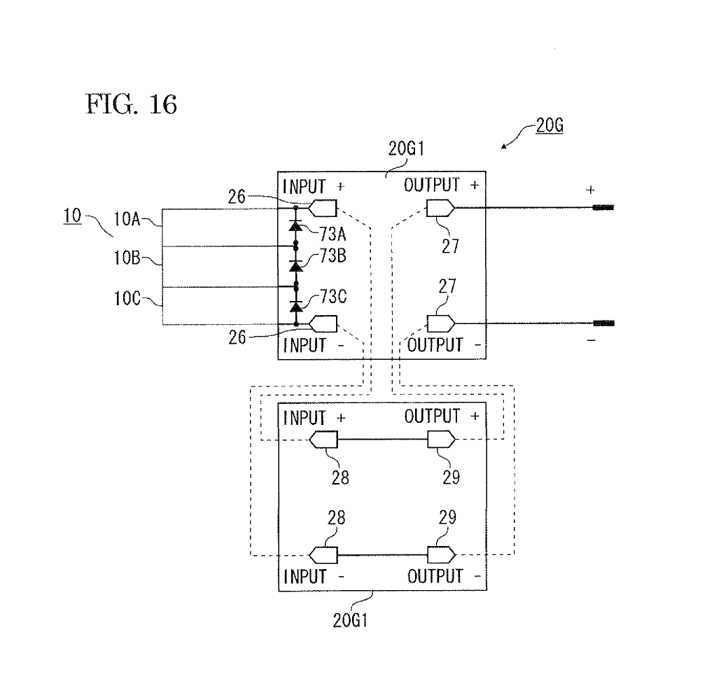

Next, Embodiment 7 will be described with reference to FIGS. 15 and 16. FIG. 15 is a diagram illustrating a sunlight panel according to Embodiment 7. FIG. 16 is a diagram illustrating a junction box according to Embodiment 7. The above-described functions and constituent elements are given the same reference numeral, and detailed description thereof will be omitted.

Generally, in the sunlight panel 10, a junction box 20G is attached on a surface opposite to a surface irradiated with the sunlight. In addition, power lines 71 and 72 for outputting power to an external device are connected to the junction box 20G. Therefore, power generated by the sunlight panel 10 is output via the junction box 20G, and the power lines 71 and 72.

In addition, the junction box 20G includes bypass diodes 73A to 73C as shown in FIG. 16. In the present embodiment, the sunlight panel 10 includes three electricity generation units 10A to 10C, and each of the electricity generation units 10A to 10C has a plurality of light emitting elements (not shown) which are connected in series to each other. Each of the bypass diodes 73A to 73C is connected in parallel to each of the electricity generation units 10A to 10C, and has a function of bypassing a current which flows through each of the electricity generation units 10A to 10C. For example, in a case where the electricity generation unit 10A fails, a current flows not through the electricity generation unit 10A but through the bypass diode 73A. Thereby, even in a case where some of the electricity generation units (or electricity generation elements forming the electricity generation units) fail, it is possible to suppress a current flowing through a string formed by a plurality of sunlight panels 10 from being shut off.

In addition, in the same manner as in the above-described embodiment, the junction box 20G includes a bypass unit 20G1 and a connection unit 20G2. In addition, since the connection unit 20G2 are separable from the bypass unit 20G1, the junction box 20G enables the conversion units 20B2 and 20D2, the monitoring unit 20E2, or the like to be easily installed in the sunlight panel 10.

In the following description, the above-described MPPT devices 20A, 20B, 20C, 20D and 20E, monitoring device 20E, connection device 20F and junction box 20G are referred to as a connection device 200. In addition, the bypass units 20B1, 20D1, 20E1, 20F1 and 20G1 are referred to as a first housing 201, and the conversion units 20B2 and 20D2, the monitoring unit 20E2, and the connection units 20F2 and 20G2 are referred to as a second housing 202.

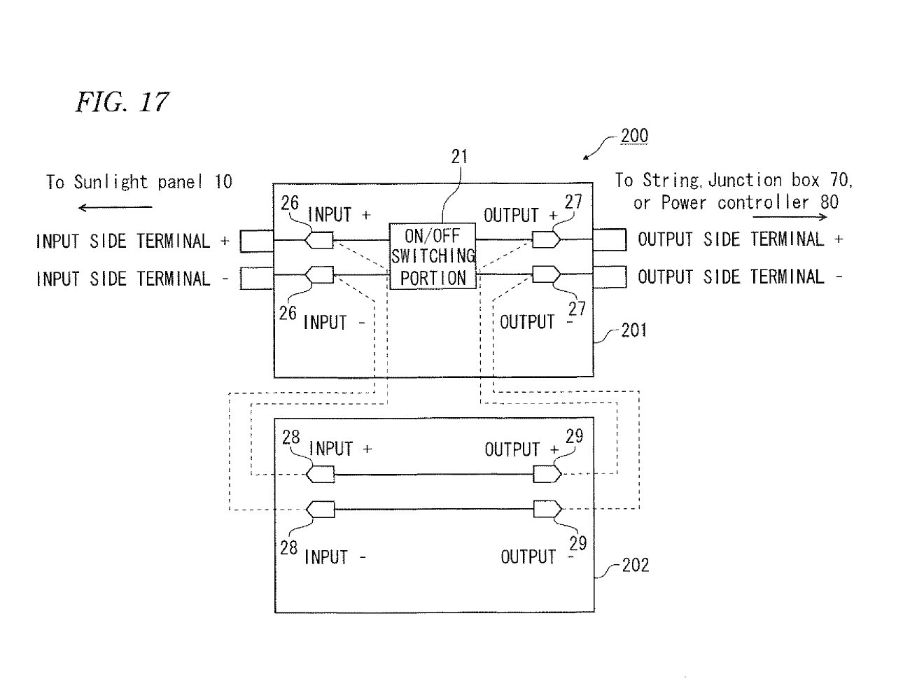

As shown in FIG. 17, the connection device 200 includes the first housing 201 and the second housing 202.

The first housing 201 is connected between the sunlight panel 10 and a string in which a plurality of sunlight panels 10 are connected. Specifically, the first housing 201 has a pair of input side terminals, and is connected to the sunlight panel 10 via the pair of input side terminals. In addition, the first housing 201 has a pair of output side terminals, and is connected to the string via the pair of output side terminals. Further, a connection destination of the output side terminals of the first housing 201 may be the connection box 70 or the power controller 80.

Furthermore, the first housing 201 includes a pair of connection terminals 26 and a pair of connection terminals 27. The pair of connection terminals 26 are respectively connected to the pair of input side terminals via power lines. These power lines are accommodated in the first housing 201. The pair of connection terminals 27 are respectively connected to the pair of output side terminals via power lines. These power lines are accommodated in the first housing 201.

In addition, the connection device 200 has a configuration capable of electrically disconnecting the connection terminals 26 and 27. For example, the ON/OFF switching portion 21 electrically disconnects the connection terminals 26 and 27 as in the bypass units 20B1, 20D1 and 20E1. Alternatively, power lines for connection between the connection terminals 26 and 27 are not disposed as in the bypass units 20F1 and 20G1. With the above-described configuration, the first housing 201 can transmit power from the sunlight panel 10 to the second housing 202.

The second housing 202 includes a pair of connection terminals 28 and a pair of connection terminals 29. The pair of connection terminals 28 are respectively connected to the pair of connection terminals 26, and the pair of connection terminals 29 are respectively connected to the pair of connection terminals 27. The pair of connection terminals 28 are respectively connected to the pair of connection terminals 29 via power lines. These power lines are accommodated in the second housing 202.

Since the connection device 200 is configured in the above-described way, the second housing 202 can be easily detached from the first housing 201 connected to the sunlight panel 10. Therefore, in the connection device 200, it is possible to easily repair or exchange the second housing 202. For this reason, a worker can easily repair and upgrade the sunlight electricity generation system 1.

In addition, although, in the above-described embodiment, the connection device 200 includes the first housing 201 and the second housing 202, the second housing 202 may be omitted. The first housing 201 may include the ON/OFF switching portion 21 in lieu of the second housing 202 as in the bypass units 20B1, 20D1 and 20E1. The ON/OFF switching portion 21 can change an output destination of the first housing 201 to the connection terminals 26 or the output side terminals. However, in order to suppress deterioration in the connection terminals 26 and 27, the connection terminals 26 and 27 are preferably protected by a protective member or the like so as not to be exposed to outside.

As above, the connection device 200 may use the second housing 202 or may use the ON/OFF switching portion 21 in order to connect the connection terminals 26 to the connection terminals 27. That is, the second housing 202 has the same function as the ON/OFF switching portion 21. In other words, the second housing 202 and the ON/OFF switching portion 21 electrically connect and disconnect the connection terminals 26 to and from the connection terminals 27. That is, the second housing 202 and the ON/OFF switching portion 21 are a connection control portion which controls a connection state between the connection terminals 26 and the connection terminals 27, or a connection changing portion which changes the connection state.

in addition, the above-described Embodiments 1 to 7 may be appropriately combined. For example, in a case where the second housing 202 has a communication function, a communication portion of the second housing 202 may be the wireless communication portion 253 or the wired communication portion 254.

Although sunlight electricity generation has been described in the above-described Embodiments 1 to 7, the present invention is not limited thereto, and the MPPT may be appropriately used when the MPPT is necessary for electricity generation using other natural energies. For example, the present invention is applicable to wind power generation or water power generation.

The present application is based upon and claims the benefit of Japanese patent application No. 2012-131619 filed on Jun. 11, 2013, the contents of which are incorporated by reference in its entirety.

The present invention is applicable to a voltage conversion apparatus which performs the maximum power point tracking used for electricity generation such as sunlight electricity generation, or a monitoring device which monitors electricity generation circumstances of sunlight electricity generation or the like, a power generation system having the device, and a power conversion method.

What is claimed is:

1. A voltage conversion apparatus for converting a voltage of an electricity generator, comprising:
a maximum power tracking portion that is adapted to output a voltage which is output by the electricity generator to an external device at a predetermined ratio such that an operation point of the electricity generator tracks an optimal operation point at which power of the electricity generator reaches a maximum level; and
a voltage output portion that is adapted to output a voltage which is output by the electricity generator to the external device when the maximum power tracking portion is not being operated normally.

2. The voltage conversion apparatus according to claim 1, further comprising:
a first housing that accommodates the voltage output portion; and
a second housing that accommodates the maximum power tracking portion, wherein
the first housing and the second housing are separable from each other.

3. The voltage conversion apparatus according to claim 2, wherein
input and output terminals of the voltage output portion are provided on outside of the first housing,
input and output terminals of the maximum power tracking portion are provided on outside of the second housing to be connected to the input and output terminals of the voltage output portion, and
the input and output terminals of the voltage output portion and the input and output terminals of the maximum power tracking portion are disposed so as not to be exposed to outside of the voltage conversion apparatus when the first housing is connected to the second housing.

4. The voltage conversion apparatus according to claim 1, wherein
the electricity generator generates power by using a photovoltaic.

5. A power generation system comprising:
a plurality of electricity generators; and
the voltage conversion apparatus according to claim 1, connected to each of the plurality of electricity generators, wherein
the plurality of electricity generators are connected in series to each other via the voltage conversion apparatuses.

6. A voltage conversion method for converting a voltage of an electricity generator, comprising:
outputting a voltage which is output by the electricity generator to an external device at a predetermined ratio such that an operation point of the electricity generator tracks an optimal operation point at which power of the electricity generator reaches a maximum level; and
outputting a voltage which is output by the electricity generator to the external device when a normal operation fails in outputting the voltage at the predetermined ratio.

7. A connection device for outputting power from a sunlight panel, comprising:
a first housing; and
a second housing, wherein
the first housing includes:
an input side terminal that is connected to the sunlight panel;
an output side terminal that can output the power to outside of the first housing;
a first connection terminal that is connected to the input side terminal; and
a second connection terminal that is connected to the output side terminal,
the second housing includes:
a third connection terminal; and
a fourth connection terminal that is connected to the third connection terminal, and
the first connection terminal is connected to the third connection terminal, and the second connection terminal is connected to the fourth connection terminal.

8. A connection device comprising:
a housing;
an input side terminal that is connected to a sunlight panel;
an output side terminal that can output power of the sunlight panel to outside of the housing;
a first connection terminal that is connected to the input side terminal;
a second connection terminal that is connected to the output side terminal; and
a connection control portion that is adapted to control an electrical connection state between the first connection terminal and the second connection terminal.
